(19) United States
(12) Patent Application Publication
(10) Pub. No.: US 2026/0346064 A1
(43) Pub. Date: Nov. 5, 2026

(54) FIRE EXTINGUISHING STRUCTURE OF BATTERY BOX

(71) Applicant: DIJIYA ENERGY SAVING TECHNOLOGY INC., Taoyuan County (TW)

(72) Inventor: Wen-Hung HUANG, Taoyuan County (TW)

(21) Appl. No.: 19/194,418

(22) Filed: Apr. 30, 2025

(51) Int. Cl. A62C 3/16; A62C 37/38; H01M 10/48; H01M 10/613; H01M 10/65

(52) U.S. Cl. CPC A62C 3/16; A62C 37/38; H01M 10/486; H01M 10/613; H01M 10/65

(57) ABSTRACT

The invention is a fire extinguishing structure for a battery box, which has a box body having side panels surrounded to form at least one space for accommodating and positioning at least one battery core module and at least one fire extinguisher, wherein any fire extinguisher has a valve connected to at least one injection port, the at least one injection port is located above the at least one battery core module with an injection direction toward the top of the battery core module; and at least one sensor located above the battery core module and connected to the valve, when the sensor senses high temperature in the battery box, the valve is automatically opened to allow the fire extinguishing agent in the fire extinguisher to be sprayed outward through the at least one injection port, so as to immediately perform the fire extinguishing action.

### FIELD OF THE INVENTION

The present invention is related to a fire extinguishing structure for a battery box, especially one that can automatically spray the fire extinguishing agent to immediately perform the fire extinguishing action when it senses high temperature inside the battery box.

### BACKGROUND OF THE INVENTION

The conventional battery box mainly has a plurality of battery cells connected in parallel or in series inside a box body. The battery cells are electrochemically synthesized. A positive conductive pole and a negative conductive pole are provided outside the box body, so as to output a fixed current or voltage after being connected to the conductive terminals respectively. When a plurality of battery boxes is assembled vertically or horizontally in parallel to form an energy storage system, it can provide sufficient DC power for mobile equipment such as electric vehicles or fixed equipment such as large machinery. Based on safety considerations, the conventional fire extinguishing method on the market is to place a fire extinguisher at the periphery of the battery box. When a lithium battery cell catches fire due to thermal runaway caused by a short circuit, the fire extinguisher can be opened manually and then the fire extinguishing agent can be sprayed out to perform the fire extinguishing action.

However, the plurality of battery cells is arranged in parallel or in series and gathered inside the box. When a lithium battery cell catches fire and generates high temperature due to a short circuit, the fire extinguisher outside the battery box cannot directly perform the fire extinguishing action at the fire point of the battery core. The fire extinguishing agent can only be sprayed on the outer surface of the battery box, and then wait for the plurality of battery cells to be burned out. As a result, not only fails to immediately extinguish the fire to prevent further spread of the fire when the lithium battery cell starts to catch fire, but also has a risk that all battery cells will be completely burned out, and the fire may spread to mobile equipment such as electric vehicles or fixed equipment such as large machinery.

### SUMMARY OF THE INVENTION

Accordingly, the present invention has developed a new design which may avoid the above-described drawbacks, may significantly enhance the performance of the devices and may take into account economic considerations. Therefore, the present invention then has been invented.

The main object of the present invention is to provide a fire extinguishing structure for a battery box that can solve the problem that conventional fire extinguisher can only spray the fire extinguishing agent on the outer surface of the battery box manually, but cannot immediately extinguish the flames inside the battery box to prevent all battery cells from being completely burned or the fire from expanding; and, through the structure that both at least fire extinguisher and at least one battery core module are accommodated and positioned in a box body, an injection direction of at least one injection port is toward a top of the battery core module, and a sensor is positioned above the battery core module, when the sensor senses high temperature, it can automatically open a valve to allow the fire extinguishing agent in the fire extinguisher to be sprayed on the top of the battery core module that is on fire through the at least one injection port, so as to immediately cover and extinguish the flames, thereby ensuring the safe use.

In order to achieve the object of the invention, the present invention provides a fire extinguishing structure for a battery box which mainly comprises a box body, at least one fire extinguisher and at least one sensor. The box body has a plurality of side panels. The plurality of side panels is surrounded to form at least one first space for accommodating and positioning at least one battery core module. The at least one fire extinguisher is corresponding to and accommodated in the at least one first space. Any one of the at least one fire extinguisher has a valve. The valve is in communication with at least one injection port, the at least one injection port is located above the at least one battery core module, and an injection direction of the at least one injection port is toward a top of the at least one battery core module. At least one sensor is located above the at least one battery core module. The at least one sensor is connected to the valve. When the at least one sensor senses high temperature, the valve is opened to allow the fire extinguishing agent in the at least one fire extinguisher to be sprayed outward through the at least one injection port.

In implementation, the box body has a rectangular shape. Two opposite ends of the box body along a long direction of the box body are defined as a front end and a rear end of the box body respectively. The box body has four side panels. The four side panels are surrounded to form the at least one first space between the front end and the rear end of the box body. Any one of the at least one first space includes a second space and a third space. The second space and the third space are arranged along the long direction of the box body. Any one of the at least one battery core module is accommodated and positioned in the second space. The at least one fire extinguisher is accommodated and positioned in the third space.

In implementation, the at least one battery core module includes a first battery core module and a second battery core module arranged in parallel. The at least one injection port is located above the first battery core module and the second battery core module respectively, and the injection direction of the at least one injection port is toward a top of the first battery core module and a top of the second battery core module respectively.

In implementation, the fire extinguisher includes a body and the valve. A first end of the body has an export end. The valve includes an adapter and a switching member. The adapter has a tube channel. The export end is in communication with the at least one injection port through the tube channel. The switching member is positioned in the tube channel in a movable manner for switching the connection of the tube channel and the at least one injection port to be in a closed or communicated state.

In implementation, the adapter includes a valve body and a sleeve portion. A first end of the valve body is in communication with the export end, a second end of the valve body has a first connection portion. A first end of the sleeve portion has a second connection portion for connecting to the first connection portion. A second end of the sleeve portion has at least one tube joint and a position-limiting space. The at least one tube joint is corresponding to and in communication with the at least one injection port. The position-limiting space is in communication with the tube channel. The switching member is positioned in the position-limiting space in a movable manner.

In implementation, the present invention further comprises a cap. A first end of the cap is connected to the second end of the sleeve portion. A second end of the cap has a through hole and a stand portion. The sensor is a temperature sensing glass tube with a long shape. The stand portion supports and positions the sensor. A first end of the sensor abuts against the through hole. The first end of the sleeve portion has a blocking portion inside. The switching member includes a piston and an elastic member. A first end of the piston has a piston rod. The piston rod passes through the through hole, and a first end of the piston rod abuts against the first end of the sensor. A first end of the elastic member abuts against a second end of the piston, a second end of the elastic member abuts against the blocking portion, such that the switching member is positioned in the position-limiting space in a movable manner.

In implementation, at least one side of the adapter is connected to at least one long tube member. The at least one long tube member has the at least one injection port.

In implementation, the battery core module includes a plurality of battery cells arranged in parallel. Any one of the at least one long tube member has a plurality of injection ports arranged at intervals along an axial direction of the at least one long tube member. The plurality of injection ports is correspondingly disposed above the plurality of battery cells respectively.

For further understanding the characteristics and effects of the present invention, some preferred embodiments referred to drawings are in detail described as follows.

### BRIEF DESCRIPTION OF DRAWINGS

FIG. 1 is an exploded perspective view of a preferred embodiment of the present invention.

FIG. 2 is an exploded view of components of a fire extinguisher and a sensor of the preferred embodiment of the present invention.

FIG. 3 is a cross-sectional diagram of the fire extinguisher and the sensor of the preferred embodiment of the present invention.

FIG. 4 is a schematic diagram of the preferred embodiment of the present invention in a use state.

### DETAILED DESCRIPTIONS OF PREFERRED EMBODIMENTS

The present invention mainly comprises a box body, at least one fire extinguisher and at least one sensor. The box body has a plurality of side panels. The plurality of side panels is surrounded to form at least one first space for accommodating and positioning at least one battery core module. The at least one fire extinguisher is corresponding to and accommodated in the at least one first space. Any fire extinguisher has a valve. The valve is in communication with at least one injection port. The at least one injection port is located above the at least one battery core module, and an injection direction of the at least one injection port is toward a top of the at least one battery core module. The at least one sensor is located above the at least one battery core module, and the at least one sensor is connected to the valve. When the at least one sensor senses high temperature in the box body, the valve is opened to allow the fire extinguishing agent in the at least one fire extinguisher to be sprayed outward through the at least one injection port, so as to immediately perform the fire extinguishing action.

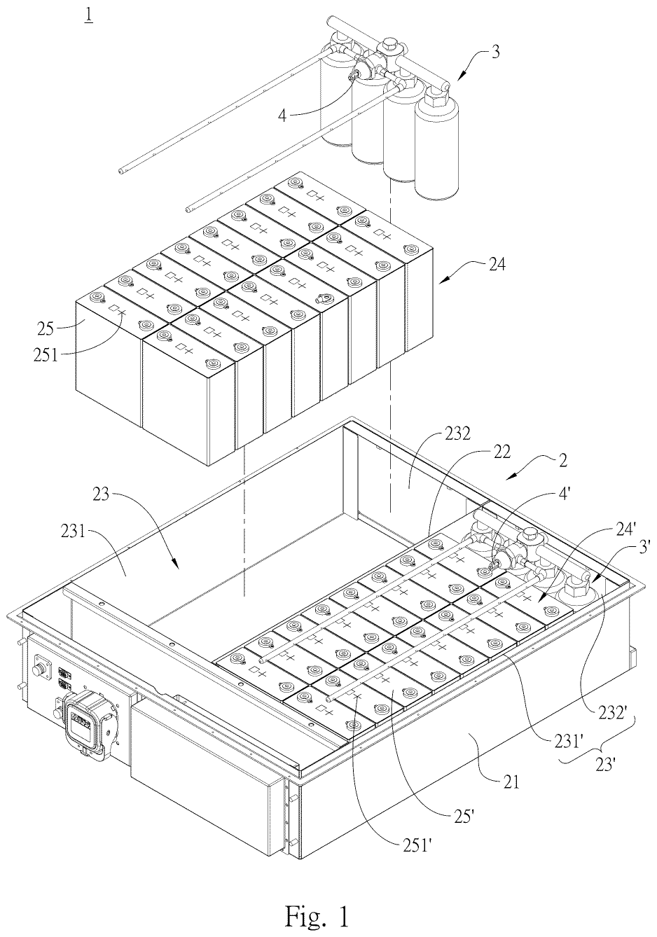

Please refer to FIG. 1, which shows a preferred embodiment of a fire extinguishing structure 1 for a battery box of the present invention. It mainly comprises a box body 2, two fire extinguisher sets (3, 3′) and two sensors (4, 4′). The box body 2 has a rectangular cubic shape. Two opposite ends of the box body 2 along a long direction of the box body 2 are defined as a front end and a rear end of the box body 2 respectively. Four side panels 21 are surrounded between the front end and the rear end of the box body 2. Two ends of a partition plate 22 are connected to an inner surface of side panel 21 at the front end and the rear end of the box body 2 respectively, so that two first spaces (23, 23′) are separated inside the box body 2. One of the first spaces (23, 23′) include a second space 231 and a third space 232; while the other of the first spaces (23, 23′) include a second space 231′ and a third space 232′. Two second spaces (231, 231′) and two third spaces (232, 232′) are arranged along the long direction of the box body 2 respectively, and the two second spaces (231, 231′) are closer to the front end than the two third spaces (232, 232′). The second space 231 of the first space 23 accommodates and positions a first battery core module 24, the third space 232 accommodates and positions the fire extinguisher set 3; the second space 231′ of the first space 23′ accommodates and positions a second battery core module 24′, the third space 232′ is used for accommodating and positioning the fire extinguisher set 3′. The first battery core module 24 and the second battery core module 24′ are arranged in parallel, and the first battery core module 24 and the second battery core module 24′ each includes a plurality of battery cells (25, 25′) arranged in parallel respectively. A top of each of the battery cells (25, 25′) has a pressure relief opening (251, 251′).

The two fire extinguisher sets (3, 3′) have the same structure. The two sensors (4, 4′) have the same structure. The two fire extinguisher sets (3, 3′) are accommodated in the two third spaces (232, 232′) respectively, and the two sensors (4, 4′) are located above the first battery core module 24 and the second battery core module 24′ respectively. The following is an explanation using a fire extinguisher set 3 and a sensor 4 as an example.

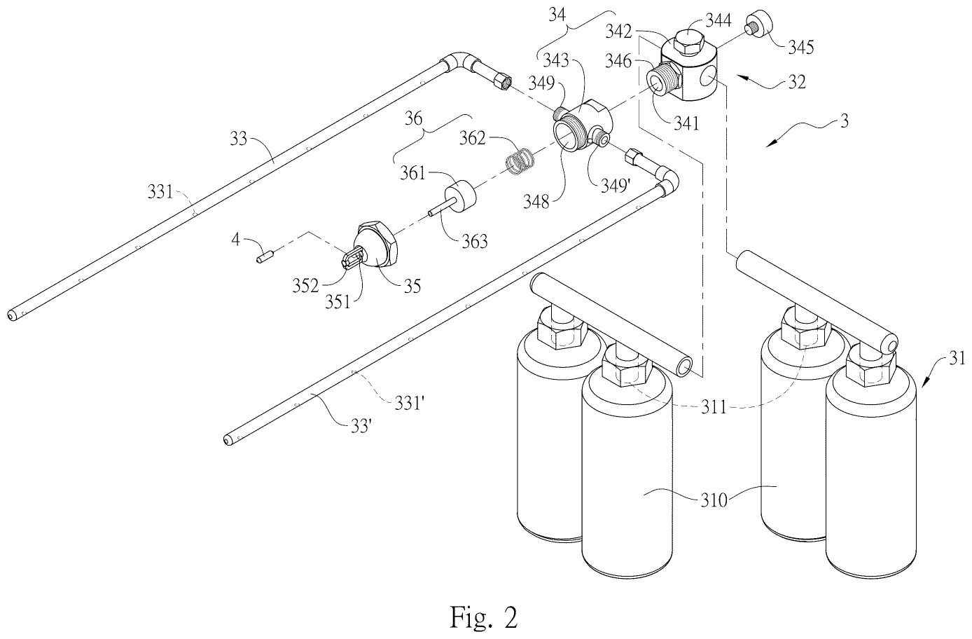

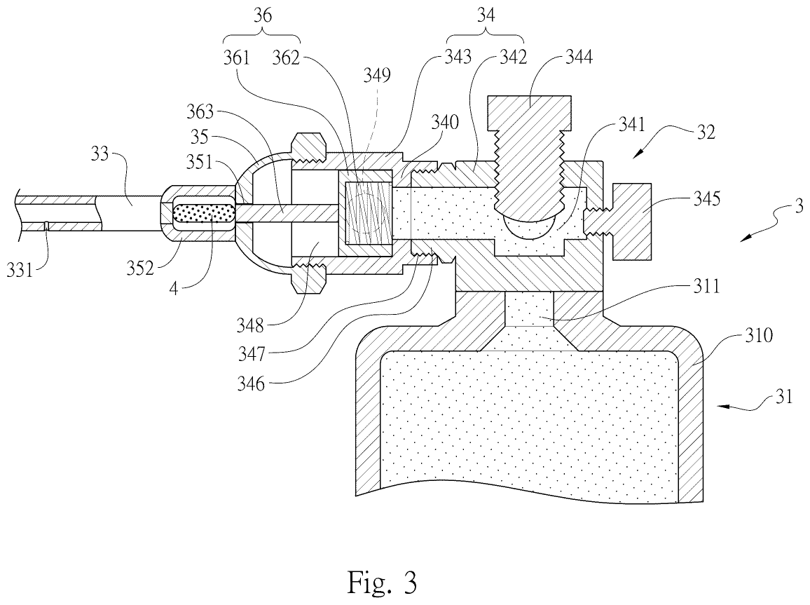

As shown in FIGS. 2 and 3, the fire extinguisher set 3 mainly includes a body 31, a valve 32 and two long tube members (33, 33′). The body 31 includes four fire extinguishers 310 arranged in parallel. A top of each fire extinguisher 310 has an export end 311 for filling in or spraying out the fire extinguishing agent. In implementation, the body 31 may include a tank-shaped fire extinguisher 310. The valve 32 mainly includes an adapter 34, a cap 35 and a switching member 36. The adapter 34 has a tube channel 341 inside, and the adapter 34 includes a valve body 342 and a sleeve portion 343. The valve body 342 is in communication with the export end 311. A knob switch 344 is screwed in to connect to a top of the valve body 342, so that after screwing the knob switch 344, a bottom end of the knob switch 344 may block the connection of the tube channel 341 or allow the fire extinguishing agent to pass through the tube channel 341. A pressure gauge 345 is screwed in to connect to one side of the valve body 342, so as to sense the pressure inside the body 31. The other side of the valve body 342 has an external threaded tube. The external threaded tube serves as a first connection portion 346.

One end of the sleeve portion 343 has an internal threaded hole for screwing in to connect to the external threaded tube of the valve body 342. In implementation, the internal threaded hole serves as a second connection portion 347. The other end of the sleeve portion 343 has a position-limiting space 348 and two tube joints (349,349′). The position-limiting space 348 is a circular groove inside the sleeve portion 343. The position-limiting space 348 is in communication with the tube channel 341 of the adapter 34. One axial end of the position-limiting space 348 has an inner protruded ring protruding radially inward. The inner protruded ring serves as a blocking portion 340. The two tube joints (349,349′) are connected to two radial ends of the sleeve portion 343 respectively, so that one end of each of the two tube joints (349,349′) can be in communication with the position-limiting space 348 respectively. One end of the cap 35 is screwed in to connect to the other end of the sleeve portion 343. The other end of the cap 35 has a through hole 351 and a stand portion 352. The sensor 4 is a temperature sensing glass tube with a long shape. The stand portion 352 supports and positions the sensor 4, and let one end of the sensor 4 abut against the position of the through hole 351.

The switching member 36 includes a piston 361 and an elastic member 362. One end of the piston 361 has a piston rod 363. One end of the piston rod 363 passes through the through hole 351 of the cap 35 and abuts against the one end of the sensor 4. The elastic member 362 is a compression spring. One end of the elastic member 362 abuts against the other end of the piston 361. The other end of the elastic member 362 abuts against the blocking portion 340 inside the sleeve portion 343, such that the switching member 36 is positioned in the position-limiting space 348 of the sleeve portion 343 in a movable manner.

One end of each of the two long tube members (33, 33′) is screwed in to connect to and in communication with the other end of each of the two tube joints (349,349′) respectively. The long tube member 33 has a plurality of injection ports 331 arranged at intervals along an axial direction of the long tube member 33 respectively. The long tube member 33′ has a plurality of injection ports 331′ arranged at intervals along an axial direction of the long tube member 33′ respectively. The plurality of injection ports (331, 331′) is correspondingly disposed above the plurality of battery cells 25 of the first battery core module 24 respectively, and an injection direction of the plurality of injection ports (331, 331′) is toward the pressure relief openings 251 on a top of the first battery core module 24 respectively.

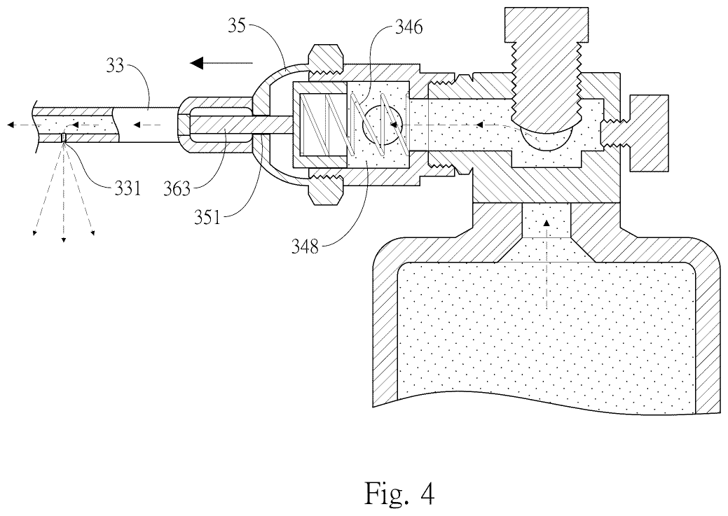

Thus, as shown in FIGS. 1-4, when one of the battery cells 25 of the first battery core module 24 catches fire due to a short circuit and raises the temperature to a high temperature, temperature sensing glass tube will automatically blast when the sensor 4 senses the temperature above a predetermined temperature (such as 90 °C). The elastic force of the elastic member 362 makes the piston rod 363 passing through the through hole 351 of the cap 35, in the meantime, makes the piston 361 moves linearly in the position-limiting space 348, so that the fire extinguishing agent passes the through the position-limiting space 348, and then through the plurality of injection ports (331, 331′) of the two long tube members (33, 33′) respectively sprays downwards on the top of the plurality of battery cells 25, so that the fire extinguishing agent respectively covers on the top of the plurality of battery cells 25, and the fire extinguishing agent penetrates into the interior of the battery cells 25 through the pressure relief openings 251 of the battery cells 25, so as to immediately cover and extinguish the flames. When one of the battery cells 25′ of the second battery core module 24′ catches fire due to a short circuit and the sensor 4′ automatically blasts when the sensor 4′ senses the temperature above 90 °C, then the fire extinguishing agent of the other fire extinguisher set 3′ will spray downwards on the top of the plurality of battery cells 25′, the flames generated by the second battery core module 24′ can also be cover and extinguish immediately.

As disclosed in the above description and attached drawings, the present invention can indeed achieve the expected object, providing a fire extinguishing structure for a battery box that can automatically open a valve when a sensor senses high temperature, so that the fire extinguishing agent in the fire extinguisher can be sprayed through at least one injection port to the top of a battery core module that is on fire, so as to immediately cover and extinguish the flames, thereby ensuring the safe use of the battery box. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A fire extinguishing structure for a battery box, comprising:
a box body having a plurality of side panels, the plurality of side panels is surrounded to form at least one first space for accommodating and positioning at least one battery core module;
at least one fire extinguisher, the at least one fire extinguisher is corresponding to and accommodated in the at least one first space, any one of the at least one fire extinguisher has a valve, the valve is in communication with at least one injection port, the at least one injection port is located above the at least one battery core module, and an injection direction of the at least one injection port is toward a top of the at least one battery core module; and
at least one sensor located above the at least one battery core module, the at least one sensor is connected to the valve, when the at least one sensor senses high temperature, the valve is opened to allow a fire extinguishing agent in the at least one fire extinguisher to be sprayed outward through the at least one injection port.

2. The fire extinguishing structure for the battery box according to claim 1, wherein the box body has a rectangular shape, two opposite ends of the box body along a long direction of the box body are defined as a front end and a rear end of the box body respectively, the box body has four side panels, the four side panels are surrounded to form the at least one first space between the front end and the rear end of the box body; any one of the at least one first space includes a second space and a third space, the second space and the third space are arranged along the long direction of the box body, one of the at least one battery core module is accommodated and positioned in the second space, and the at least one fire extinguisher is accommodated and positioned in the third space.

3. The fire extinguishing structure for the battery box according to claim 1, wherein the at least one battery core module includes a first battery core module and a second battery core module arranged in parallel, the at least one injection port is located above the first battery core module and the second battery core module respectively, and the injection direction of the at least one injection port is toward a top of the first battery core module and a top of the second battery core module respectively.

4. The fire extinguishing structure for the battery box according to claim 1, wherein the fire extinguisher includes a body and the valve, a first end of the body has an export end; the valve includes an adapter and a switching member, the adapter has a tube channel, the export end is in communication with the at least one injection port through the tube channel; and the switching member is positioned in the tube channel in a movable manner for switching the connection of the tube channel and the at least one injection port to be in a closed or communicated state.

5. The fire extinguishing structure for the battery box according to claim 4, wherein at least one side of the adapter is connected to at least one long tube member, and the at least one long tube member has the at least one injection port.

6. The fire extinguishing structure for the battery box according to claim 5, wherein the battery core module includes a plurality of battery cells arranged in parallel, any one of the at least one long tube member has a plurality of injection ports arranged at intervals along an axial direction of the at least one long tube member, the plurality of injection ports is correspondingly disposed above the plurality of battery cells respectively.

7. The fire extinguishing structure for the battery box according to claim 4, wherein the adapter includes a valve body and a sleeve portion, a first end of the valve body is in communication with the export end, a second end of the valve body has a first connection portion; a first end of the sleeve portion has a second connection portion for connecting to the first connection portion, a second end of the sleeve portion has at least one tube joint and a position-limiting space, the at least one tube joint is corresponding to and in communication with the at least one injection port; the position-limiting space is in communication with the tube channel, and the switching member is positioned in the position-limiting space in a movable manner.

8. The fire extinguishing structure for the battery box according to claim 7, wherein at least one side of the adapter is connected to at least one long tube member, and the at least one long tube member has the at least one injection port.

9. The fire extinguishing structure for the battery box according to claim 8, wherein the battery core module includes a plurality of battery cells arranged in parallel, any one of the at least one long tube member has a plurality of injection ports arranged at intervals along an axial direction of the at least one long tube member, and the plurality of injection ports is correspondingly disposed above the plurality of battery cells respectively.

10. The fire extinguishing structure for the battery box according to claim 7, further comprising a cap, a first end of the cap is connected to the second end of the sleeve portion, a second end of the cap has a through hole and a stand portion; the sensor is a temperature sensing glass tube with a long shape, the stand portion supports and positions the sensor, a first end of the sensor abuts against the through hole; the first end of the sleeve portion has a blocking portion inside; the switching member includes a piston and an elastic member, a first end of the piston has a piston rod, the piston rod passes through the through hole, and a first end of the piston rod abuts against the first end of the sensor; a first end of the elastic member abuts against a second end of the piston, a second end of the elastic member abuts against the blocking portion, such that the switching member is positioned in the position-limiting space in a movable manner.

11. The fire extinguishing structure for the battery box according to claim 10, wherein at least one side of the adapter is connected to at least one long tube member, the at least one long tube member has the at least one injection port.

12. The fire extinguishing structure for the battery box according to claim 11, wherein the battery core module includes a plurality of battery cells arranged in parallel, any one of the at least one long tube member has a plurality of injection ports arranged at intervals along an axial direction of the at least one long tube member, the plurality of injection ports is correspondingly disposed above the plurality of battery cells respectively.
